(19) United States
(12) Patent Application Publication
(10) Pub. No.: US 2010/0320346 A1
(43) Pub. Date: Dec. 23, 2010

(54) FIXING

(76) Inventor: Gareth Phillips, Essex (GB)

Correspondence Address: Rodney L. Skoglund;Renner, Kenner, Greive, Bobak,Taylor & Weber, Fourth Floor, First National Tower, Akron, OH, 44308-1456, US

(21) Appl. No.: 12/865,163

(22) PCT Filed: Jan. 29, 2009
(86) PCT No.: PCT/GB09/00252

§ 371 Date: Jul. 29, 2010

(30) Foreign Application Priority Data
Jan. 30, 2008 (GB) 0801668.5

(51) Int. Cl. F16M 13/00

(52) U.S. Cl. 248/309.1

(57) ABSTRACT

The present invention provides a fixing (10) for an item (11). The fixing comprises a first attachment (20) with a front face (23) to be adhesive bonded to a surface (50) of the item to define a bonding interface (51). It also comprises a cover (14), arranged to overlie at least part of the first attachment, and having a first seal (35) arranged to seal to the surface of the item around the first attachment to define a sealed chamber around edges of the bonding interface. The cover may be attached to the first attachment after adhesion and there may be further seals (38). A shank (26) may be provided on the first attachment and extends through a hole formed in the cover. A second attachment (15) may interconnect the shank and other items.

The present invention relates to a fixing to be bonded to an item to mount that item on a support structure. The present invention is particularly well suited for use in mounting a sign to a supporting surface such as a wall, but although it will predominantly be described with reference to that use it is by no means limited to such use and may be used to interconnect components of a structure.

Many different types of fixings are available for mounting an item to a supporting surface, and these differ considerably depending on their quality, the characteristics of the item, the characteristics or environment of the supporting surface and the means by which they are secured to the item and the supporting surface. Some fixings, particularly those used for mounting an ornamental item (such as a sign or glass construction) to a supporting surface are required to have an attractive appearance. Indeed, in many cases the fixing would be located behind the ornamental item and so it would not usually be visible but in some arrangements the fixings would be visible, particularly if the item is made of glass or another transparent material.

Furthermore, some items include no fastening formations to aid fastening (either for structural or aesthetic reasons), such as holes or bolts, to which the fixing can be connected and so it is necessary to bond the fixing to the item using a suitable adhesive. One particular fixing used for fixing a sign to a wall includes a female part to be fastened on a wall and a male part to be bonded to the sign, the male part can then be inserted into the female part and a grub screw is provided to hold the parts together. A main problem with this kind of fixing is that the bond between the item and the male part deteriorates over time, particularly when mounted outdoors where it is exposed to the elements.

An object of the present invention is to provide a fixing that may be bonded to an item to be mounted either indoors or outdoors and which fixing includes means by which the adhesive bond is protected. A further object of the present invention is to provide such a fixing which has an attractive appearance.

According to the invention there is provided a fixing for an item comprising:
a first attachment having a front face adapted to be bonded to a surface of the item to define a bonding interface;
a cover arranged to overlie at least part of the first attachment and having a first seal arranged sealingly to engage the surface of the item around the first attachment to define a sealed chamber around edges of the bonding interface.

The first attachment may be used to attach the item to another, whether directly or indirectly. The item may be mounted on something else or something may be mounted on the item. The first attachment may be part of an object to be connected to the item.

The sealed chamber around the bonding interface prevents the external environmental conditions adversely affecting the bond. Such external environmental conditions may include weather, moisture and pollutants present in the air/water.

Advantageously, a second seal is provided on one of the first attachment and the cover sealingly to engage the other of the first attachment and cover. The advantage of this second seal is that it can reduce the size of the sealed chamber and improve the integrity thereof. When a chamber is sealed it contains air with contaminants, so the smaller the sealed chamber the less air and contaminants are in contact with the adhesive.

Preferably the cover has an end face which bears on the surface, and the first seal is provided on that face. Preferably the cover also has an internal surface that overlies a rear part of the first attachment, and the second seal is provided between that internal surface and rear part. The first and second seals may be defined by the faces themselves if suitably formed, but preferably the seals comprise O-rings or equivalent sealing devices which adapt to conform to the surfaces against which they bear and may be compressed to improve sealing. The cover, or that part which defines the front face, may be formed from a resilient material such that it may form the seal to the surface without the need to provide a separate seal. Nevertheless, O-rings are particularly advantageous because they provide the necessary continuous seal for creating the sealed chamber and they deform elastically under load to conform to any surface irregularities. Preferably, such seals are located in recesses provided on the end face and/or interior surface, the first and second seals being adapted to locate in these recesses to inhibit inadvertent displacement thereof. Only part of each such seal locates in its recess, the remainder projects beyond the surface in which its recess is formed and in use engages the first attachment or item.

Advantageously, a pin (also referred to as a shank) extends rearwardly from the first attachment for the connection to other objects. The pin may be integral to the first attachment or it may be provided with a threaded portion which engages a threaded recess provided on a rear face of the first attachment. When the first attachment has such a pin, the cover may require a hole to be formed therethrough. The hole in the cover may be threaded and arranged to engage a threaded portion of the pin, so that the cover may be screwed onto the pin and first attachment by rotation of the cover relative to the first attachment until the seals engage the surface of the item and/or first attachment, respectively.

In an alternative arrangement the cover may include a pin and the cover may have a threaded portion adapted to engage a threaded portion provided on the first attachment.

Furthermore, there may also be provided a second attachment arranged to be secured to a support such as a wall or the like and connected to the first attachment or the cover. The second attachment may comprise a boss having a large bore formed at least partway therethrough and in which large bore the pin locates. A small bore may be formed in the second attachment and this may extend normal to and intersect the large bore, the small bore may be threaded and may be adapted to receive a grub screw which engages the pin when located in said large bore. The pin on the cover or first attachment may be connected to the second attachment by a variety of means including the provision of cooperating screw threads as well as the use of push fitting.

In a preferred arrangement the front face of the first attachment corresponds to the surface of the item to which it is to be bonded and most preferably both faces are substantially planar. Similarly the end face of the cover, which like the surface may not be planar, corresponds to the surface of the item against which it bears. Furthermore, the internal face of the cover preferably corresponds to the rear parts of the first attachment.

With the exception of the seal or seals the fixing of the present invention may be constructed from solid materials, such as metal or plastics. The front face of the first attachment may be provided with means to improve the bonding. The term bonding as used herein encompasses the attachment of one surface to another by any appropriate means. It includes the use of adhesives or treatments (chemical, thermal, sonic or mechanical) to activate the respective surfaces to allow them to join. The present invention provides a desirable appearance to a finished item so may be used when a bonding interface is not subject to degradation if not sealed. However it is primarily intended for use where the interface is potentially subject to such degradation.

The seal may be provided by a flowable sealant, such as silicone, that will cure after application. This may during assembly be provided inside the cover or on the rear of the first attachment such that when the cover is placed on the first attachment the sealant flows between the cover and the surface to define a first seal, and potentially a second seal as well. The cover may also be adhered to the first attachment, potentially by that sealant.

By way of example only, one specific embodiment of the invention will now be described in detail, with reference to the accompanying drawings in which:

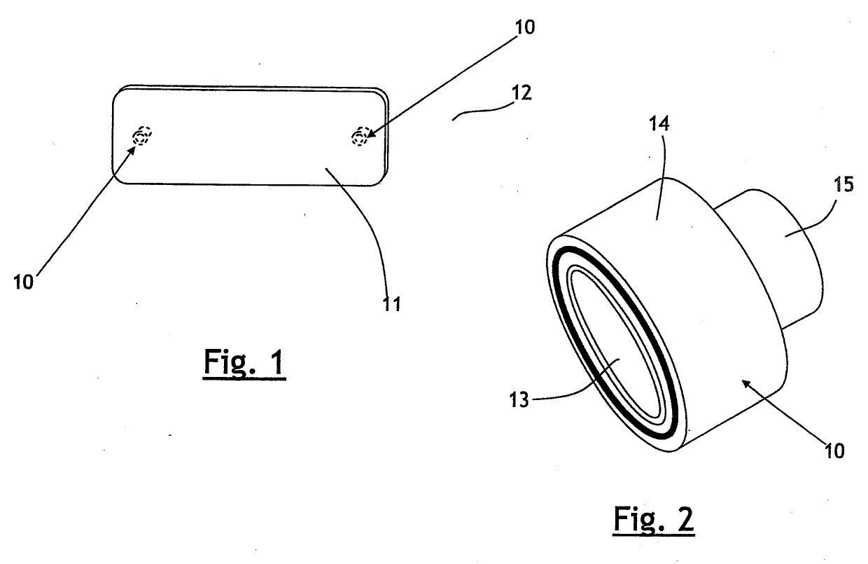

FIG. 1 is a perspective view of a sign mounted to a wall by two fixings of the present invention;

FIG. 2 is an enlarged view of one of the fixings shown in FIG. 1;

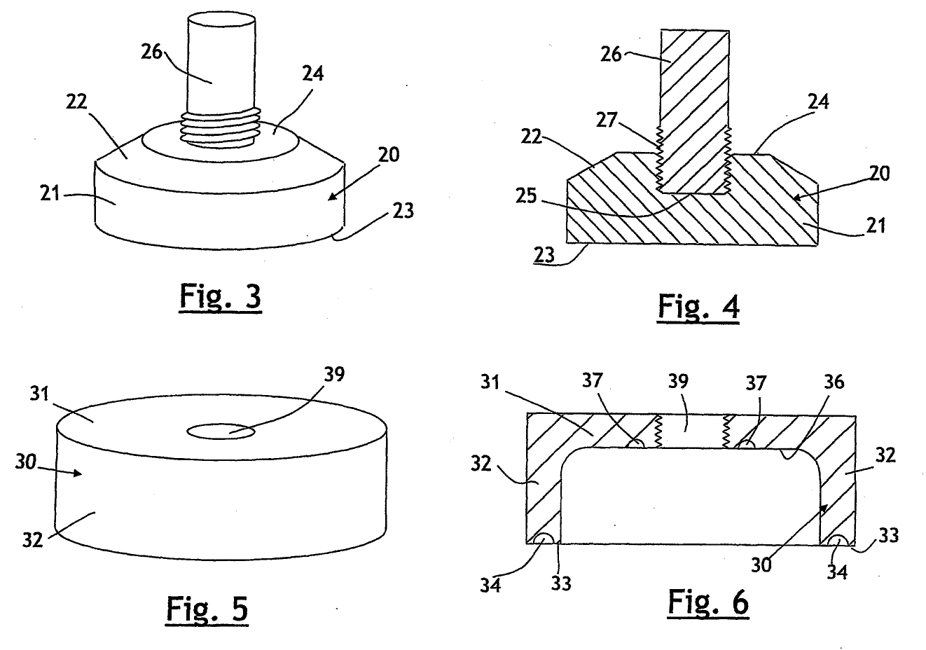

FIG. 3 is a perspective view of a first part of the fixing shown in FIG. 2, which is to be bonded to an item;

FIG. 4 is a cross-sectional view through the first part shown in FIG. 3;

FIG. 5 is a perspective view of a cover forming part of the fixing shown in FIG. 2;

FIG. 6 is a cross-sectional view through the cover shown in FIG. 5;

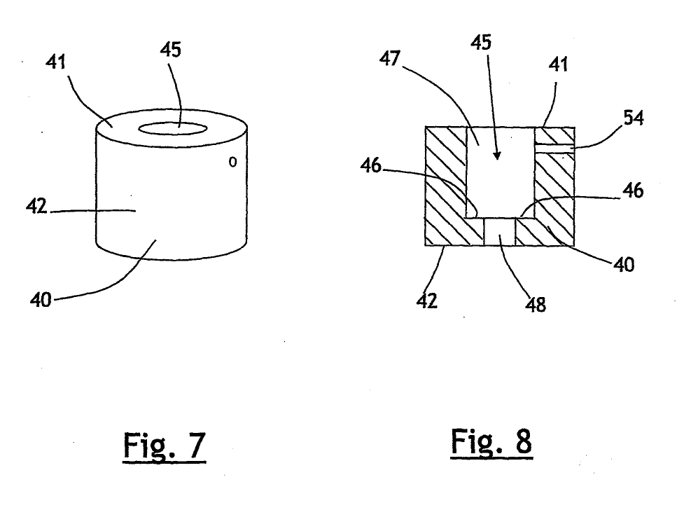

FIG. 7 is a perspective view of a second part of the fixing shown in FIG. 2, which is to be fastened to a supporting wall;

FIG. 8 is a cross-sectional view through the second part shown in FIG. 7; and

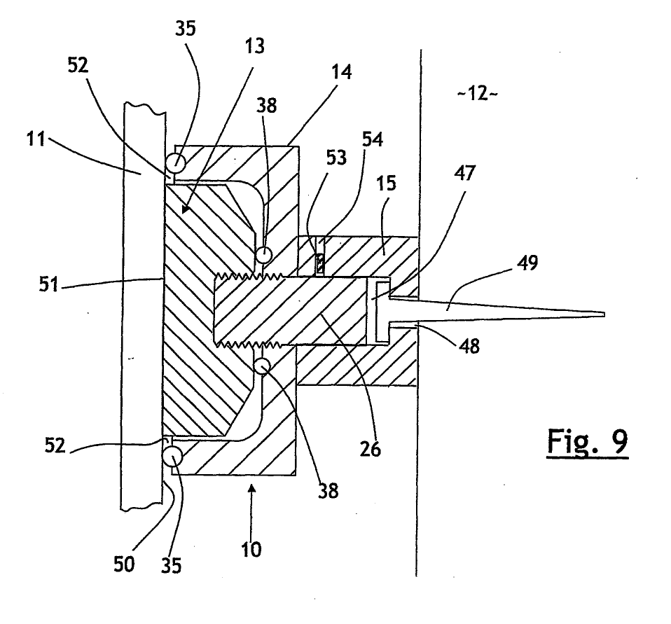

FIG. 9 is a cross-section through the assembled fixing while connecting an item to a supporting wall.

Referring to FIGS. 1 and 2 there is shown a fixing generally indicated 10 for mounting a sign 11 on a wall 12. The fixing comprises a first part 13 which is bonded to the sign 11, a cover 14 which overlies the first part 13 and a second part 15 which is fastened to the supporting wall 12 and which is to be connected to the first part 13.

The first part 13 is shown in more detail in FIGS. 3 and 4, and includes a main body 20 having a cylindrical front portion 21 and a frusto-conical rear portion 22, the front portion 21 defining a front face 23 and the frusto-conical portion 22 defining a smaller rear face 24. A threaded bore 25 is provided in the centre of the rear face 24 and a pin 26 having a threaded end portion 27 is screwed into the bore, the length of the threaded portion being longer than the depth of the bore 25 so that several turns of the thread remain visible.

Referring now to FIGS. 5 and 6 there is shown the cover 30 having a circular base 31 and an annular wall 32 extending from the periphery of the base. The annular wall 32 has an end face 33 remote from the base 31 in which there is provided an annular groove 34 adapted to receive an O-ring 35 (see FIG. 9). The internal face 36 of the base also is provided with an annular groove 37 adapted to receive a second O-ring 38 (see FIG. 9). A threaded bore 39 is formed through the centre of the base 31 and arranged to engage the threaded portion 27 of the pin 26.

The second part is shown in FIGS. 7 and 8 and comprises a cylindrical boss 40 having opposed front and rear circular faces 41, 42, the front face of the boss being adapted to abut the rear face of the cover and the rear face of the boss being adapted to lie against the wall 12 to which the sign 11 is to be mounted. A bore 45 is formed in the boss and extends along the central axis of the boss through the centre of the front and rear faces 41, 42. The bore 45 narrows partway along its length to define a shoulder 46 delineating a diametrically larger portion 47 near the front face 41 and a diametrically smaller portion 48 near the rear face 42. The boss 40 is secured to the wall 12 by a screw (numbered 49 in FIG. 9) having a shank which extends through the diametrically smaller portion and into the wall and a head which bears against the shoulder 46. A small threaded bore 54 is formed through the circumferential wall of the boss and extends normal to and intersects the diametrically larger portion 47 of the bore 45. A grub screw 53 threadingly engages the small bore and can be tightened to project into the diametrically small portion 47.

In use, the front face 23 of the first part 13 is bonded to a rear face 50 of the sign 11 by a suitable adhesive to form a bonding interface 51. The cover 14 is then fitted to the first part 13 by screwing the threaded bore 39 of the cover onto the pin 26 until the first O-ring 35 sealingly engages the rear face 50 of the sign 11 and the second O-ring 38 sealingly engages the rear face 24 of the first part 13. In this way a sealed chamber 52 is created which prevents the bonding interface 51 from being exposed to the environment. When the cover 14 is fully screwed onto the first part 13 the threaded portion 27 does not extend beyond the rear face of the cover 14.

The second part 15 is mounted on to the wall 12 by a screw as described above. The sign 11 is then presented near the wall 12 and the pin 26 inserted into the diametrically larger portion 47 of the boss 40 and the grub screw 53 is tightened so as to engage the pin 26 and secure it in position.

In most cases at least two fixings 10 would be required securely to mount a sign 11 to a wall 12 and some heavy, larger signs would require more fixings. In which case the same installation procedure as described above should be adapted but care would be required to ensure the spacing between the first parts 13 bonded to the sign 11 correspond to the spacing between the second parts 15 fastened to the wall 12.

The present invention provides a mechanism for bonding onto surfaces, which gives high strength and resistance to degradation. This can be used to mount one item on another or even to fix multiple items together, one or more being bonded to fixings according to the present invention. This can allow for the construction of complicated structures, especially of glass with fixings that do not require the cutting of holes, but which are visually appealing.

1. A fixing for an item comprises:
a first attachment having a front face adapted to be bonded to a surface of the item to define a bonding interface;
a cover arranged to overlie at least part of the first attachment and having a first seal arranged sealingly to engage the surface of the item around the first attachment to define a sealed chamber around edges of the bonding interface.

2. A fixing as claimed in claim 1, wherein one or more second seal is provided on one of the first attachment and the cover sealingly to engage the other of the first attachment and cover.

3. A fixing as claimed in claim 1, wherein the cover has an end face on which the first seal is provided.

4. A fixing as claimed in claim 3, wherein the cover also has an internal surface that overlies a rear part of the first attachment, and wherein a second seal is present and is provided between that internal surface and rear part.

5. A fixing as claimed in claim 3, further comprising a first groove provided on the end face, in which groove the first seal locates.

6. A fixing as claimed in claim 4, further comprising a second groove provided on the interior surface, in which groove the second seal locates.

7. A fixing as claimed in claim 1, wherein a shank extends rearwardly from the first attachment or cover.

8. A fixing as claimed in claim 7 wherein the shank is formed on the first attachment and in use extends through a hole formed in the cover.

9. A fixing as claimed in claim 8, wherein the shank is integral to the first attachment.

10. A fixing as claimed in claim 8 wherein the shank threadingly engages a recess provided on the rear face of the first attachment.

11. A fixing as claimed in claim 8, wherein the hole in the cover is threaded and arranged to engage a threaded portion provided on the shank.

12. A fixing as claimed in claim 1, further comprising a second attachment to be secured to a support and connected to the first attachment either directly or by means of the cover.

13. A fixing as claimed in claim 12, wherein the second attachment comprises a boss having a bore formed at least partway therethrough and in which bore a shank that extends rearwardly from the first attachment or cover locates.

14. A fixing as claimed in claim 2, wherein at least one of the first and second seals comprise O-rings.

15. A fixing as claimed in claim 1 wherein the front face matches the surface of the item to which it is to be bonded.

16. A fixing as claimed in claim 3, wherein the end face matches the surface of the item around the bonding interface against which it bears.

17. A fixing as claimed in claim 4, wherein the internal surface of the cover corresponds to the rear part of the first attachment.

18. A fixing as claimed in claim 2, wherein at least one of the first and second seal is provided by a flowable sealant that will cure after application.

19. A fixing as claimed in claim 1, wherein the cover is attached to the first attachment by adhesive.
